(19) United States
(12) Patent Application Publication
(10) Pub. No.: US 2025/0180359 A1
(43) Pub. Date: Jun. 5, 2025

(54) EVACUATION SUPPORT SYSTEM, EVACUATION SUPPORT APPARATUS, EVACUATION SUPPORT METHOD, AND NON-TRANSITORY COMPUTER READABLE MEDIUM

(71) Applicant: NEC Corporation, Minato-ku, Tokyo (JP)

(72) Inventors: Shuei YAMADA, Tokyo (JP); Shintaro CHIKU, Tokyo (JP); Naoko FUKUSHI, Tokyo (JP); Masanori KUKI, Tokyo (JP); Shuhei MIZUGUCHI, Tokyo (JP); Kosei KOBAYASHI, Tokyo (JP)

(73) Assignee: NEC Corporation, Minato-ku, Tokyo (JP)

(21) Appl. No.: 18/842,849

(22) PCT Filed: Mar. 10, 2022
(86) PCT No.: PCT/JP2022/010741

§ 371 Date: Aug. 30, 2024

(51) Int. Cl. G01C 21/20; G06V 20/54

(52) U.S. Cl. CPC G01C 21/206; G06V 20/54

(57) ABSTRACT

An evacuation support system (1001) according to the present disclosure is an evacuation support apparatus including an acquisition unit (1), an evacuation route generation unit (2), and a notification unit (3). The acquisition unit (1) acquires position information of an evacuee's original place and crowdedness information of an evacuation destination candidate. An evacuation route generation unit (2) determines an evacuation destination based on the crowdedness information, and generates an evacuation route from the evacuee's original place to the determined evacuation destination. A notification unit (3) notifies an evacuee of the generated evacuation route.

### TECHNICAL FIELD

The present disclosure relates to an evacuation support system, an evacuation support apparatus, an evacuation support method, and a non-transitory computer readable medium.

### BACKGROUND ART

Patent Literature 1 discloses an in-facility information providing system which, when an abnormality occurs, displays on a display device abnormal time information including an evacuation route in accordance with the place where the display device is installed. The in-facility information providing system disclosed in Patent Literature 1 guides evacuees (e.g., people present in the facility at the time of an emergency or the like) to a predetermined evacuation place.

### CITATION LIST

### Patent Literature

Patent Literature 1: Japanese Unexamined Patent Publication No. 2017-091228

### SUMMARY OF INVENTION

### Technical Problem

As described above, the in-facility information providing system disclosed in Patent Literature 1 guides evacuees to a predetermined evacuation place. Therefore, in the in-facility information providing system disclosed in Patent Literature 1, there is a problem that even when the evacuation place is already crowded with a large number of evacuees, it still guides additional evacuees to the evacuation place, so that the efficiency of the evacuation deteriorates.

The present disclosure has been made to solve such a problem, and an object thereof is to provide an evacuation support system, an evacuation support apparatus, an evacuation support method, and a non-transitory computer readable medium capable of improving the efficiency of evacuation.

### Solution to Problem

An evacuation support system according to an aspect of the present disclosure includes:
an acquisition unit configured to acquire position information of an evacuee's original place and crowdedness information of an evacuation destination candidate;
an evacuation route generation unit configured to determine an evacuation destination based on the crowdedness information, and generate an evacuation route from the evacuee's original place to the determined evacuation destination; and
a notification unit configured to notify an evacuee of the generated evacuation route.

An evacuation support apparatus according to an aspect of the present disclosure includes:
a storage unit in which an evacuation destination candidate is stored; and
an arithmetic unit configured to acquire crowdedness information of the evacuation destination candidate, determine an evacuation destination based on the crowdedness information, and generate an evacuation route from an evacuee's original place to the determined evacuation destination.

An evacuation support method according to an aspect of the present disclosure includes:
a step of acquiring crowdedness information of an evacuation destination candidate;
a step of determining an evacuation destination based on the crowdedness information;
a step of generating an evacuation route from an evacuee's original place to the determined evacuation destination; and
a step of notifying an evacuee of the generated evacuation route.

A non-transitory computer readable medium according to an aspect of the present disclosure is a non-transitory computer readable medium storing a program for causing a computer to perform:
a step of acquiring crowdedness information of an evacuation destination candidate;
a step of determining an evacuation destination based on the crowdedness information;
a step of generating an evacuation route from an evacuee's original place to the determined evacuation destination; and
a step of notifying an evacuee of the generated evacuation route.

### Advantageous Effects of Invention

According to the present disclosure, it is possible to provide an evacuation support system, an evacuation support apparatus, an evacuation support method, and a non-transitory computer readable medium capable of improving the efficiency of evacuation.

### BRIEF DESCRIPTION OF DRAWINGS

FIG. 1 is a block diagram showing a configuration of an evacuation support system according to a first example embodiment;

FIG. 2 is a block diagram showing a configuration of an evacuation support system according to a second example embodiment;

FIG. 3 is a flowchart showing operations performed by the evacuation support system according to the second example embodiment;

FIG. 4 is a block diagram showing a configuration of an evacuation support system according to a third example embodiment;

FIG. 5 is a block diagram showing a configuration of an evacuation guiding apparatus according to the third example embodiment;

FIG. 6 is a block diagram showing a configuration of an evacuation support system according to a fourth example embodiment; and

FIG. 7 is a block diagram showing a configuration of an evacuation guiding apparatus according to the fourth example embodiment.

### EXAMPLE EMBODIMENT

### First Example Embodiment

### <Configuration of Evacuation Support System>

A configuration of an evacuation support system according to a first example embodiment will be described hereinafter in detail with reference to the drawings.

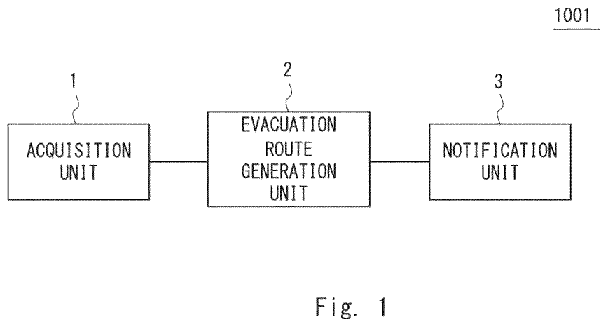

FIG. 1 is a block diagram showing the configuration of the evacuation support system according to the first example embodiment.

The evacuation support system 1001 according to the first example embodiment includes an acquisition unit 1, an evacuation route generation unit 2, and a notification unit 3.

The acquisition unit 1 acquires position information of an evacuee's original place and crowdedness information of an evacuation destination candidate.

The evacuation route generation unit 2 determines an evacuation destination based on the crowdedness information thereon. The evacuation route generation unit 2 generates an evacuation route from the evacuee's original place to the determined evacuation destination.

The notification unit 3 notifies evacuees of the generated evacuation route.

As described above, the evacuation support system 1001 according to this example embodiment determines an evacuation destination based on acquired crowdedness information of an evacuation destination candidate, and then generates an evacuation route.

By the above-described configuration, the evacuation support system 1001 according to this example embodiment can guide evacuees to an evacuation destination which is less crowded, and thereby improve the efficiency of the evacuation.

### Second Example Embodiment

### <Configuration of Evacuation Support System>

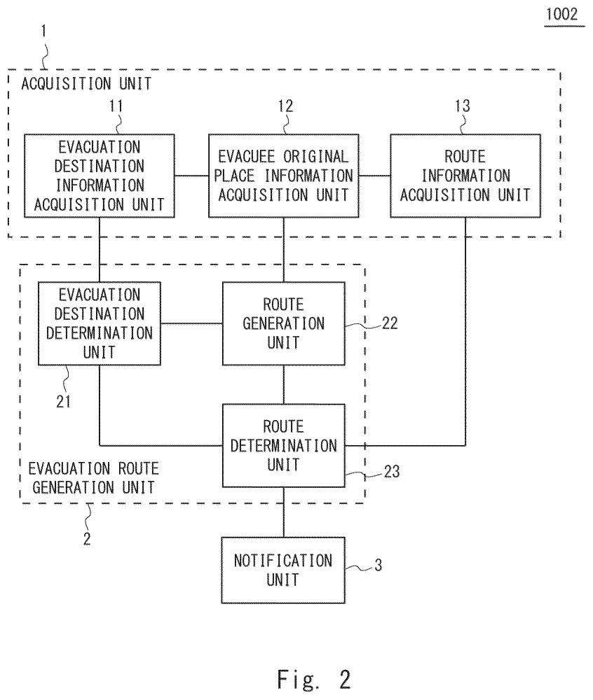

A configuration of an evacuation support system according to a second example embodiment will be described hereinafter in detail with reference to the drawings. FIG. 2 is a block diagram showing the configuration of the evacuation support system according to the second example embodiment.

The evacuation support system 1002 according to this example embodiment is a system for efficiently guiding evacuees when an accident or the like which makes it necessary to evacuate people, such as a disaster, occurs. The evacuation support system 1002 determines an evacuation destination based on crowdedness information of an evacuation destination candidate, determines an evacuation route, and notifies evacuees of the evacuation route. Therefore, the evacuation support system 1002 is particularly effective when it is applied to a facility where there are a plurality of evacuation destination candidates, and it is likely to be crowded when a disaster occurs.

Note that the evacuation destination in this specification refers to a place or an area that is used as the destination for evacuees who escape from some danger or the like. The evacuation destination may be a place where safety can be ensured when a disaster occurs, or a place or an area that functions as an escape exit in order to allow people to escape from a place where they could be endangered when a disaster occurs.

Further, the evacuee's original place in this specification refers to a place or an area that is used as a starting point for evacuees to escape from some danger or the like. The evacuee's original place is a place or an area located in a place where people could be endangered when a disaster occurs, and may be, for example, a predetermined place or a predetermined area, or a place where evacuees who should move therefrom are currently present.

A typical example in which the evacuation support system 1002 is applied is to guide people in an emergency situation in a facility having a plurality of entrances and exits, such as a large commercial facility or a public facility. In such a case, the evacuation support system 1002 designates places where there are people moving in the facility or predetermined areas in the facility as evacuees' original places, and designates entrances and exits of the facility as evacuation destination candidates. Further, the evacuation support system 1002 may designate a predetermined area(s) outside the facility as an evacuation destination candidate(s). Examples of such a predetermined area outside the facility include a road accessible from an entrance or exit of the facility, and nearby facilities.

However, the cases in which the evacuation support system 1002 can be applied are not limited to the above-described cases. For example, the evacuation support system 1002 may be used when evacuees outside a facility are guided into the facility for evacuation, when evacuees inside a facility are guided to another area inside the same facility for evacuation, or when evacuees outdoors are guided to an outdoor evacuation destination for evacuation.

The evacuation support system 1002 according to this example embodiment includes an acquisition unit 1, an evacuation route generation unit 2, and a notification unit 3.

The acquisition unit 1 acquires, for example, position information of candidates for an evacuation destination and an evacuee's original place, and information necessary for determining an evacuation route, such as crowdedness information of an evacuation destination candidate and an evacuation route, and disaster conditions. The acquisition unit 1 may be, for example, a detection apparatus that detects information by itself, such as a photographing apparatus (or video apparatus); a receiver that receives information detected by an external apparatus; or a combination thereof.

The acquisition unit 1 includes an evacuation destination information acquisition unit 11, an evacuee original place information acquisition unit 12, and a route information acquisition unit 13.

The evacuation destination information acquisition unit 11 acquires crowdedness information of an evacuation destination candidate. The evacuation destination information acquisition unit 11 outputs the acquired crowdedness information and disaster conditions to an evacuation destination determination unit 21.

The crowdedness information of the evacuation destination may be image data obtained by photographing (or filming) the situation at the evacuation destination, crowdedness level evaluation data obtained by image-processing the image data and thereby evaluating the crowdedness level, or data including both of these data.

Note that the crowdedness level evaluation data may be obtained by detecting the number of people recorded in the image data or the population density thereof and thereby evaluating the crowdedness level, or may be obtained by evaluating the crowdedness level based on distances between people. Further, the crowdedness level evaluation data may be obtained by evaluating the crowdedness level by using artificial intelligence (AI: Artificial Intelligence) that has been trained by using images of crowds.

Further, the crowdedness information of an evacuation destination candidate may include crowdedness information of an area around the evacuation destination candidate. For example, when an entrance or exit of a facility is designated as an evacuation destination candidate for evacuees in the facility, the crowdedness information of the evacuation destination candidate may include crowdedness information of a road accessible from the entrance or exit of the facility.

The evacuation destination information acquisition unit 11 may be a photographing apparatus (or video apparatus) for photographing (or filming) the situation at an evacuation destination candidate, or may be, for example, at least one monitoring camera mounted at a position from which the monitoring camera can photograph (or film) the evacuation destination.

When the evacuation destination information acquisition unit 11 is a photographing apparatus, the evacuation destination information acquisition unit 11 transmits image data taken by itself or crowdedness level evaluation data generated by image-processing the image data to the evacuation destination determination unit 21.

That is, the evacuation destination information acquisition unit 11 may be a photographing apparatus including a photographing unit that takes an image, and a transmitting unit that transmits the image as image data, or may be a photographing apparatus further including an image processing unit that image-processes such image data and thereby generates crowdedness level evaluation data.

The evacuation destination information acquisition unit 11 may be a receiver that receives crowdedness information of an evacuation destination candidate from the outside (e.g., from an external apparatus or the like). In this case, the evacuation destination information acquisition unit 11 may acquire image data photographed (or filmed) by a photographing apparatus located outside the system, or crowdedness level evaluation data output from an external server.

Examples of the photographing apparatus located outside the system include an on-board camera of a vehicle running in the vicinity the evacuation destination and a surveillance camera installed by a municipality or the like.

Further, the evacuation destination information acquisition unit 11 may acquire information about the evacuation destination candidate other than the crowdedness information thereof.

For example, the evacuation destination information acquisition unit 11 may acquire information as to whether or not there is an emergency vehicle in the evacuation destination candidate. In this case, the evacuation destination information acquisition unit 11 may receive emergency vehicle dispatch information and thereby acquire information as to whether or not there is an emergency vehicle in the evacuation destination candidate. Further, information as to whether or not there is an emergency vehicle in an evacuation destination candidate may be acquired by analyzing image data obtained by photographing the evacuation destination candidate. The evacuation destination information acquisition unit 11 may notify the evacuation destination determination unit 21 of whether or not there is an emergency vehicle in the evacuation destination candidate, and when there is an emergency vehicle there, further notify the evacuation destination determination unit 21 of the type of the emergency vehicle.

Further, the evacuation destination information acquisition unit 11 may acquire congestion information of a road in the vicinity of the evacuation destination candidate from an external system that collects and processes road traffic information, such as a vehicle information and communication system (VICS: Vehicle Information and Communication System (Registered Trademark)), and output the acquired congestion information to the evacuation destination determination unit 21.

The evacuee original place information acquisition unit 12 acquires position information of the evacuee's original place. The evacuee original place information acquisition unit 12 outputs the acquired position information of the evacuee's original place to a route generation unit 22.

Note that the evacuee original place information acquisition unit 12 may acquire a place where evacuees are currently present as the position information of the evacuee's original place, or may acquire position information of a predetermined place or a predetermined area.

Further, when the notification unit 3 (which will be described later) includes a display unit that displays an evacuation route for evacuees, the evacuee original place information acquisition unit 12 may acquire the position information of this display unit as the evacuee's original place.

For example, when the evacuee's original place is a place where evacuees who should move therefrom are currently present, the evacuee original place information acquisition unit 12 is a receiver that receives position information of evacuees. In this case, the evacuee original place information acquisition unit 12 may receive position information from a terminal carried by an evacuee, or may receive position information of the terminal from an external server that acquires the position information of the terminal.

Further, when the evacuee's original place is a predetermined area or the position of the display unit, the evacuee original place information acquisition unit 12 may acquire position information of the evacuee's original place or the display unit from a storage unit (not shown).

Note that when the evacuee's original place is a predetermined area, the evacuation support system 1002 guides people present in this area as evacuees. Further, when the evacuee's original place is the position of the display unit, the evacuation support system 1002 guides people present in a place where they can check this display unit as evacuees.

The route information acquisition unit 13 acquires information of an evacuation route candidate from a route determination unit 23, and acquires crowdedness information of this evacuation route candidate. The route information acquisition unit 13 outputs the crowdedness information of the evacuation route candidate to the route determination unit 23.

Note that the crowdedness information output from the route information acquisition unit 13 may be, for example, image data obtained by photographing the evacuation route candidate, or crowdedness level evaluation data obtained by image-processing the image data and thereby evaluating the crowdedness level of the evacuation route.

The route information acquisition unit 13 may be a photographing apparatus (or video apparatus) for photographing (or filming) the situation at an evacuation route candidate, and may be, for example, at least one monitoring camera mounted at a position from which the monitoring camera can photograph a passageway or the like that may become an evacuation route candidate. When the route information acquisition unit 13 is a monitoring camera, it takes an image of an evacuation route candidate and outputs the image as image data to the route determination unit 23.

That is, the route information acquisition unit 13 may be a photographing apparatus including a photographing unit that takes an image, and a transmitting unit that transmits the image as image data, or may be a photographing apparatus further including an image processing unit that image-processes such image data and thereby generates crowdedness level evaluation data.

Further, the route information acquisition unit 13 may be a receiver that receives crowdedness information of an evacuation route from the outside (e.g., from an external apparatus or the like). In this case, the route information acquisition unit 13 may acquire image data photographed (or filmed) by a photographing apparatus located outside the system, or crowdedness level evaluation data output from an external server.

Note that the route information acquisition unit 13 does not have to acquire an evacuation route candidate from the route determination unit 23. In this case, the route information acquisition unit 13 outputs the whole crowdedness information that it can acquire by itself to the route determination unit 23.

That is, the route information acquisition unit 13 may acquire crowdedness information of some or all passageways that can become evacuation route candidates, and output the acquired crowdedness information to the route determination unit 23.

The route information acquisition unit 13 may acquire information about the evacuation route candidate other than the crowdedness information thereof. For example, the route information acquisition unit 13 may acquire a damaged state or the like of a route caused by a disaster and output the acquired damaged state or the like to the route determination unit 23.

The evacuation route generation unit 2 generates an evacuation route based on the information acquired by the acquisition unit 1. The evacuation route generation unit 2 may be implemented by, for example, a computer apparatus. In this case, the processing performed by the evacuation route generation unit 2 is implemented by, for example, having an arithmetic unit of the computer apparatus road and execute an evacuation support program in which the processing performed by the evacuation route generation unit 2 is implemented.

The evacuation route generation unit 2 includes an evacuation destination determination unit 21, a route generation unit 22, and a route determination unit 23.

The evacuation destination determination unit 21 determines an evacuation destination based on crowdedness information. More specifically, the evacuation destination determination unit 21 acquires crowdedness information of an evacuation destination candidate from the evacuation destination information acquisition unit 11, and determines an evacuation destination based on the acquired crowdedness information. The evacuation destination determination unit 21 outputs information about the determined evacuation destination to the route generation unit 22. Note that the information about the evacuation destination may be, for example, identification information of the evacuation destination or position information of the evacuation destination.

When the evacuation destination determination unit 21 is notified of a change of the evacuation destination from the route determination unit 23, it changes the evacuation destination and outputs information about the changed evacuation destination to the route generation unit 22.

The evacuation destination determination unit 21 may acquire, as the crowdedness information, image data obtained by photographing the situation at the evacuation destination candidate, or may acquire crowdedness level evaluation data. When the evacuation destination determination unit 21 acquires image data from the evacuation destination information acquisition unit 11, it image-processes the image data and thereby generates crowdedness level evaluation data.

Note that the evacuation destination determination unit 21 may predict a change in the crowdedness information of the evacuation destination candidate and determine an evacuation destination based on the predicted change in the crowdedness information of the evacuation destination candidate. In this case, the evacuation destination determination unit 21 acquires movement information of people present in the evacuation route, acquired by the route information acquisition unit 13 and predicts a change in the crowdedness information of the evacuation destination candidate based on the acquired movement information.

The evacuation destination determination unit 21 may preferentially determine (i.e., select), among a plurality of evacuation destination candidates, an evacuation destination candidate that is less crowded as the evacuation destination. When an evacuation destination is determined as described above, the evacuation support system 1002 can, by determining an evacuation destination, guide evacuees to an un-crowded evacuation destination. As a result, the evacuation destination is prevented from being excessively crowded. As the crowdedness level in the evacuation destination is reduced, the efficiency of the evacuation is improved.

It should be noted that the judging criterion that the evacuation destination determination unit 21 uses to determine an evacuation destination is not limited to the crowdedness information of the evacuation destination candidate. That is, the evacuation destination determination unit 21 may determine an evacuation destination by combining the crowdedness information of the evacuation destination candidate with other judging criteria.

For example, the evacuation destination determination unit 21 may define priorities of evacuation destination candidates in advance, and when a difference between the crowdedness levels of evacuation destination candidates is equal to or smaller than a predetermined value, determine an evacuation destination candidate having a higher priority as the evacuation destination. Further, when the difference between the crowdedness levels of evacuation destination candidates is equal to or larger than the predetermined value, the evacuation destination determination unit 21 may determine an evacuation destination candidate having a lower crowdedness as the evacuation destination.

Further, for example, when the evacuation support system 1002 is installed in a facility having a plurality of entrances and exits, and hence there are a plurality of entrances and exits as evacuation destination candidates, the evacuation support system 1002 may determine an evacuation destination based on crowdedness information and the widths of roads accessible from the entrances and exits. In this case, the evacuation destination determination unit 21 may evaluate an entrance or exit accessible from a wider road as a candidate having a higher priority. Further, the evacuation destination determination unit 21 may evaluate an entrance or exit that is far from a traffic light or an intersection as a candidate having a higher priority. By setting priorities of evacuation destination candidates in this way, evacuees can be guided to a safer evacuation destination.

Further, for example, the evacuation destination determination unit 21 may determine an evacuation destination based on crowdedness information and a distance from the evacuee's original place to the evacuation destination candidate. In this case, the evacuation destination determination unit 21 may evaluate an evacuation destination candidate closer to the evacuee's original place as a candidate having a higher priority.

Further, for example, the evacuation destination determination unit 21 may determine an evacuation destination based on crowdedness information and the presence/absence of an emergency vehicle. In this case, the evacuation destination determination unit 21 may evaluate an evacuation destination candidate in which there is no emergency vehicle as a candidate having a higher priority. When an evacuation destination is determined as described above, the crowdedness in the vicinity of an emergency vehicle is alleviated, so that the emergency vehicle can appropriately carry out a disaster relief activity.

However, when the emergency vehicle is an ambulance and an evacuee is injured, the evacuee may be guided to an evacuation destination candidate in which there is an emergency vehicle.

Note that the evacuation destination determination unit 21 may determine whether or not there is an emergency vehicle by image-processing image data obtained by photographing the evacuation destination candidate, and when it is determined that there is an emergency vehicle, infers the type of the emergency vehicle. Further, the evacuation destination determination unit 21 may determine whether or not there is an emergency vehicle in the evacuation destination candidate based on emergency vehicle dispatch information acquired by the evacuation destination information acquisition unit 11.

Further, for example, the evacuation destination determination unit 21 may determine an evacuation destination based on crowdedness information and congestion information of roads in the vicinity of the evacuation destination candidate. In this case, the evacuation destination determination unit 21 may evaluate an evacuation destination candidate in which nearby roads are less congested as a candidate having a higher priority. When an evacuation destination is determined as described above, it is possible to transfer evacuees to an evacuation destination from which they can be transported more quickly by transportation means.

Note that the evacuation destination determination unit 21 may obtain congestion information of nearby roads by image-processing image data obtained by photographing the evacuation destination candidate. Further, the evacuation destination determination unit 21 may acquire congestion information that the evacuation destination information acquisition unit 11 has acquired from an external system.

Further, for example, the evacuation destination determination unit 21 may determine an evacuation destination based on crowdedness information and the safety in the evacuation destination candidate.

In this case, the evacuation destination determination unit 21 may evaluate the safety in the evacuation destination candidate based on the disaster conditions of the evacuation destination candidate. The disaster conditions of the evacuation destination candidate may be acquired, for example, by image-processing image data obtained by photographing the evacuation destination candidate and evaluating the level of damage to buildings, installations, road surfaces, and the like.

Further, the evacuation destination determination unit may infer disaster conditions of the evacuation destination candidate in the future based on the type of the disaster that has occurred, and evaluate the safety in the evacuation destination candidate. For example, when the disaster that has occurred is a tsunami, the evacuation destination determination unit 21 may infer that an evacuation destination candidate located at a low altitude is likely to be engulfed by the tsunami, and hence evaluate the safety in the evacuation destination candidate low.

Further, for example, the evacuation destination determination unit 21 may determine an evacuation destination based on crowdedness information and information about the evacuation route. In this case, the evacuation destination determination unit 21 outputs a plurality of evacuation destination candidates to the route generation unit 22 and acquires information about evacuation routes each corresponding to a respective one of the plurality of evacuation destination candidates generated by the route generation unit 22 from the route determination unit 23.

Note that the information about evacuation routes may be one similar to information used as a judging criterion that the route determination unit 23 uses to determine an evacuation route (which will be described later).

The evacuation destination determination unit 21 may determine an evacuation destination by using a plurality of judging criteria as shown above in a combined manner.

For example, the evacuation destination determination unit 21 may assign priorities to a plurality of judging criteria, and determine (i.e., select), as the evacuation destination, an evacuation destination candidate that is determined to be prioritized based on a judging criterion having a higher priority.

Further, the evacuation destination determination unit 21 may determines a plurality of scores for each of a plurality of evacuation destination candidates based on a plurality of judging criteria, respectively, and determine (i.e., select) an evacuation destination by comparing the sum totals of the scores of the plurality of evacuation destination candidates with one another.

The route generation unit 22 generates an evacuation route candidate from the evacuee's original place to the determined evacuation destination. More specifically, the route generation unit 22 acquires information about the evacuee's original place from the evacuee original place information acquisition unit 12, acquires information about the evacuation destination from the evacuation destination determination unit 21, and generates an evacuation route candidate from the evacuee's original place to the evacuation destination. Note that the number of generated evacuation route candidates may be only one, or two or more. The route generation unit 22 outputs the generated evacuation route candidate(s) to the route determination unit 23.

Further, when the evacuation destination determination unit 21 has changed the evacuation destination, the route generation unit 22 generates an evacuation route candidate again by using the changed evacuation destination as a new evacuation destination, and outputs the generated evacuation route candidate to the route determination unit 23.

The information about the evacuation destination or the evacuee's original place acquired by the route generation unit 22 may be positional information of the evacuation destination or the evacuee's original place, or may be identification information of the evacuation destination or the evacuee's original place.

When the route generation unit 22 acquires identification information, it acquires position information associated with the identification information, stored in a storage unit (not shown) from the storage unit.

The route generation unit 22 may generate an evacuation route based on map data in which passageways usable as evacuation routes are recorded. For example, the route generation unit 22 may search for a route connecting the evacuee's original place and the evacuation destination with the shortest distance, and output the found route as an evacuation route candidate.

Further, the route generation unit 22 may search for a route other than the route connecting the evacuee's original place and the evacuation destination with the shortest distance. For example, the route generation unit 22 may output a route of which the difference of the distance from the distance of the route connecting the evacuee's original place and the evacuation destination with the shortest distance is smaller than a predetermined value as an evacuation route candidate.

Further, the route generation unit 22 may output an evacuation route candidate after excluding passageways that have become impassable. In this case, the route generation unit 22 may acquire information about passageways that have become impassable from the route information acquisition unit 13 or from the route determination unit 23 described later.

Note that examples of passageways that have become impassable include a passageway that is severely damaged by the disaster and hence passing through it is risky, and a passageway that is already crowded with evacuees and hence passing through it is ineffective.

Further, when the evacuation support system 1002 is introduced for evacuation in a facility having a plurality of levels (e.g., floors), and the level of the evacuee's original place differs from the level of the evacuation destination, the route generation unit 22 may generate an evacuation route that extends over a plurality of levels.

In this case, the route generation unit 22 may generate a route from the evacuee's original place to a relay point on a level different from the level of the evacuee's original place, such as a staircase, and generate a route from this relay point to the evacuation destination. Further, if necessary, the route generation unit 22 may generate an evacuation route from a relay point to another relay point. Then, the route generation unit 22 may combine these routes with one another and output the combined route as one evacuation route candidate.

The evacuation support system 1002 having such a configuration can guide evacuees to an evacuation destination located on a different level.

The route determination unit 23 acquires an evacuation route candidate from the route generation unit 22. The route determination unit 23 acquires a crowdedness state on the evacuation route candidate from the route information acquisition unit 13, and determines an evacuation route based on the acquired crowdedness information of the evacuation route candidate. The route determination unit 23 outputs the determined evacuation route to the notification unit 3. When the route information acquisition unit 13 is at least one monitoring camera mounted at a position from which the monitoring camera can photograph a passageway or the like, the route determination unit 23 may acquire the crowdedness state from the monitoring cameras mounted at the position from which the monitoring camera can photograph the evacuation route candidate.

Before determining the evacuation route, the route determination unit 23 may determine whether or not there is an evacuation route candidate of which the crowdedness level is within a predetermined range. When there are evacuation route candidates the crowdedness level of each of which is within the predetermined range, the route determination unit 23 determines (i.e., selects) the evacuation route from these evacuation route candidates and outputs the determined evacuation route to the notification unit 3. When there is no evacuation route candidate of which the crowdedness level is within the predetermined range, the route determination unit 23 notifies the evacuation destination determination unit 21 to determine an evacuation destination again.

For example, the route determination unit 23 may preferentially determine an evacuation route candidate of which the crowdedness level is lower as the evacuation route. When an evacuation route is determined as described above, it is possible to guide evacuees to an evacuation route along which they can evacuate quickly, so that the efficiency of the evacuation is improved. Further, since no additional evacuee is guided to an already-crowded evacuation route, the crowdedness level of the evacuation route can be controlled. As a result, the safety of evacuees who are already moving along the evacuation route is also improved.

It should be noted that the judging criterion that the route determination unit 23 uses to determine an evacuation route is not limited to the crowdedness information of the evacuation route candidate. That is, the route determination unit 23 may determine an evacuation route by combining the crowdedness information of the evacuation route candidate with other judging criteria.

For example, the route determination unit 23 may determine an evacuation route based on crowdedness information and the distance (i.e., the length) of the evacuation route candidate. In this case, the route determination unit 23 may evaluate an evacuation route candidate having a shorter moving distance (i.e., a shorter length) as a candidate having a higher priority. When an evacuation route is determined as described above, the time an evacuee requires to arrive at the evacuation destination can be shortened, so that the efficiency of the evacuation can be improved. Further, since the distance an evacuee moves is shortened, the burden on the evacuees is reduced.

Note that the distance of the evacuation route candidate may be evaluated while taking the crowdedness information of the evacuation route into consideration, and hence may be evaluated as the time required to move along the evacuation route.

Further, for example, the route determination unit 23 may determine an evacuation route based on crowdedness information and a distance from the place where the disaster has occurred to the evacuation route candidate. In this case, the route determination unit 23 may evaluate an evacuation route candidate farther from the place where the disaster has occurred as a candidate having a higher priority. When an evacuation route is determined as described above, the safety of evacuees is improved.

Further, for example, the route determination unit 23 may determine an evacuation route based on crowdedness information and the disaster conditions of the evacuation route candidate. In this case, for example, the route determination unit 23 may evaluate the level of damage to the evacuation route candidate by image-processing image data obtained by photographing the evacuation route candidate. Further, the route determination unit 23 may evaluate an evacuation route candidate of which the damage level is small as a candidate having a higher priority. When an evacuation route is determined as described above, the safety of evacuees is improved.

The route determination unit 23 may determine an evacuation route by using a plurality of judging criteria as shown above in a combined manner.

For example, the route determination unit 23 may assign priorities to a plurality of judging criteria, and determine (i.e., select), as the evacuation route, an evacuation route candidate that is determined to be prioritized based on a judging criterion having a higher priority. Further, the route determination unit 23 may determines a plurality of scores for each of a plurality of evacuation route candidates based on a plurality of judging criteria, respectively, and determine (i.e., select) an evacuation route by comparing the sum totals of the scores of the plurality of evacuation route candidates with one another.

The notification unit 3 acquires the evacuation route determined by the route determination unit 23, and notifies evacuees of the acquired evacuation route.

The notification unit 3 may notify evacuees of the evacuation route, or may notify an evacuation guide(s) who guides evacuees of the evacuation route. When the processing performed by the evacuation route generation unit 2 is carried out by a computer apparatus, the notification unit 3 may be, for example, a user interface for presenting results output from the computer apparatus to people (e.g., evacuees). Further, the notification unit 3 may be a transmitter for transmitting the evacuation route determined by the evacuation route generation unit 2 to other apparatuses.

For example, the notification unit 3 may be a transmitter that transmits information about an evacuation route to a portable terminal possessed by an evacuee or an evacuation guide. Further, the notification unit 3 may be a transmitter that uploads information about an evacuation route onto a server which a portable terminal possessed by an evacuee or an evacuation guide can access, or may be a server itself onto which information about an evacuation route is uploaded.

In such a case, the position of the terminal or a predetermined area in which the terminal is present may be determined as the evacuee's original place.

For example, the notification unit 3 may be a display unit that displays information about an evacuation route. In such a case, the notification unit 3 may be configured, for example, as a display device.

As described above, when the notification unit 3 is a display unit that displays information about an evacuation route, the position of the display unit may be determined as the evacuee's original place. Alternatively, a predetermined area including the place where the display unit is installed may be determined as the evacuee's original place.

Further, the notification unit 3 may notify evacuees of information about an evacuation route, for example, by a voice announcement.

The notification unit 3 may include the configuration shown above or other means capable of providing information about an evacuation route to evacuees.

However, the optimal means for informing an evacuee of an evacuation route changes according to the evacuee and the situation or the like at the time when the disaster has occurred. Therefore, the larger the number of types of notification means the notification unit 3 has is, the larger number of evacuees the information about an evacuation route can be provided.

### <Operation of Evacuation Support System>

Operations performed by the evacuation support system according to the second example embodiment, i.e., an evacuation support method, will be described hereinafter in detail with reference to the drawings.

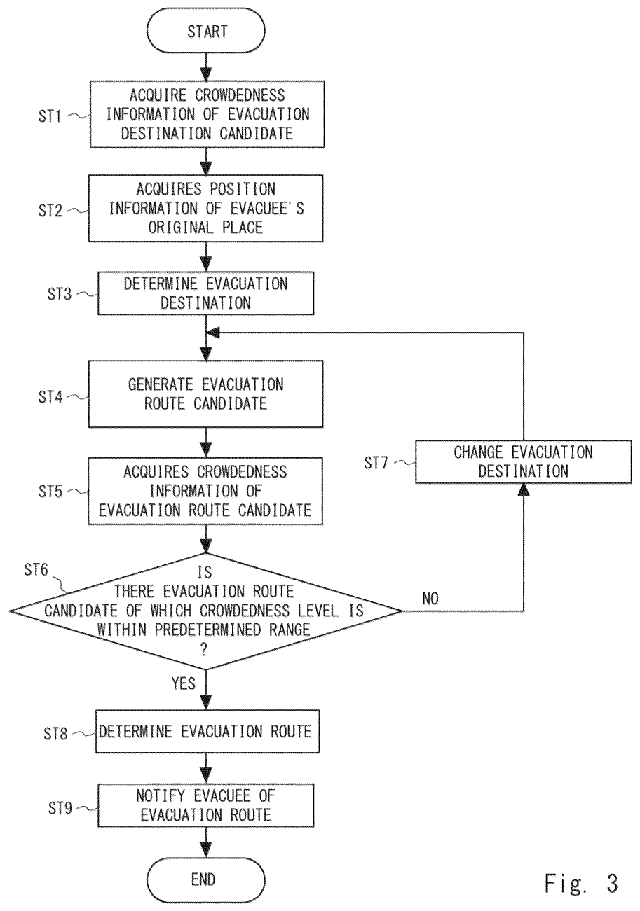

FIG. 3 is a flowchart showing operations performed by the evacuation support system according to the second example embodiment.

Firstly, the evacuation destination information acquisition unit 11 acquires crowdedness information of an evacuation destination candidate (Step ST1). Next, the evacuee original place information acquisition unit 12 acquires position information of an evacuee's original place (Step ST2).

However, the order in which the steps ST1 and ST2 are performed may be reversed. Further, the steps ST1 and ST2 may be performed in parallel with each other.

Next, the evacuation destination determination unit 21 determines an evacuation destination (Step ST3), and the route generation unit 22 creates an evacuation route candidate (Step ST4). Then, the route information acquisition unit 13 acquires crowdedness information of the evacuation route candidate (Step ST5).

Next, the route determination unit 23 determines whether or not there is an evacuation route of which the crowdedness level is within a predetermined range (Step ST6).

When there is no evacuation route of which the crowdedness level is within the predetermined range (Step ST6 No), the evacuation destination determination unit 21 changes the evacuation destination (Step ST7) and then performs the step ST4 again.

That is, the evacuation support system 1002 repeatedly performs the steps ST4 to ST7 until an evacuation route of which the crowdedness level is within the predetermined range is found.

When there is an evacuation route of which the crowdedness level is within the predetermined range (Step ST6 Yes), the route determination unit 23 determines an evacuation route (Step ST8).

Lastly, the notification unit 3 notifies evacuees of the evacuation route (Step ST9), and the evacuation support system 1002 finishes the series of operations.

As described above, the evacuation support system 1002 according to this example embodiment determines an evacuation destination based on crowdedness information of an evacuation destination candidate, determines an evacuation route, and notifies evacuees of the evacuation route. According to such a configuration, the evacuation support system 1002 can guide evacuees to an evacuation destination of which the crowdedness level is low, so that the efficiency of the evacuation can be improved. Further, since the evacuation support system 1002 can reduce the crowdedness level of an evacuation destination, the safety in the evacuation destination can be improved.

### Third Example Embodiment

### <Configuration of Evacuation Support System>

An evacuation support system 1003 according to a third example embodiment is a first specific example of the evacuation support system 1002 according to the second example embodiment. A configuration of the evacuation support system according to the third example embodiment will be described hereinafter in detail with reference to the drawings.

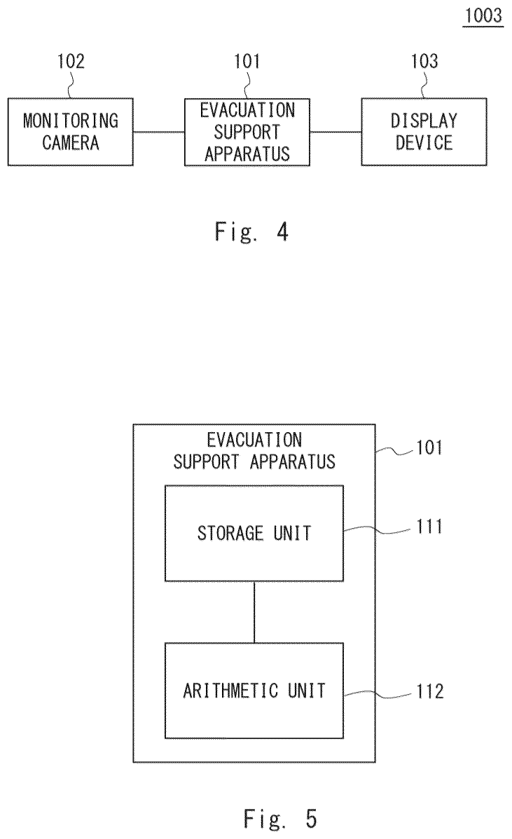

FIG. 4 is a block diagram showing a configuration of an evacuation support system according to the third example embodiment. The evacuation support system 1003 according to the third example embodiment includes an evacuation support apparatus 101, a monitoring camera 102, and a display device 103.

Note that although only one monitoring camera 102 and one display device 103 are shown in the drawing for the sake of simplicity, a plurality of monitoring cameras 102 and a plurality of display devices 103 may be provided.

The monitoring camera 102 is a monitoring camera that photographs (or films) an evacuation destination candidate and a passageway or the like that may become an evacuation route candidate, and outputs the obtained image data to the evacuation support apparatus 101. That is, the monitoring camera 102 corresponds to the evacuation destination information acquisition unit 11 and the route information acquisition unit 13 in the second example embodiment.

The display device 103 is a display device that acquires an evacuation route from the evacuation support apparatus 101 and presents the acquired evacuation route to evacuees. That is, the display device 103 corresponds to the notification unit 3 in the first and second example embodiments.

Further, the display device 103 may be regarded as the evacuee's original place, and may transmit its own position information to the evacuation support apparatus 101. In this case, the display device 103 also corresponds to the evacuee original place information acquisition unit 12 according to the second example embodiment.

The evacuation support apparatus 101 acquires image data of an evacuation destination candidate and a passageway or the like that may become an evacuation route candidate from the monitoring camera 102. The evacuation support apparatus 101 evaluates the crowdedness levels of the evacuation destination candidate and the evacuation route candidate by image-processing the image data, and determines an evacuation route based on the evaluated crowdedness levels. Then, the evacuation support apparatus 101 outputs the determined evacuation route to the display device 103. That is, the evacuation support apparatus 101 corresponds to the evacuation route generation unit 2 in the first and second example embodiments.

FIG. 5 is a block diagram showing a configuration of an evacuation support apparatus according to the third example embodiment. The evacuation support apparatus 101 according to the third example embodiment includes a storage unit 111 and an arithmetic unit 112.

The arithmetic unit 112 loads software, i.e., a computer program, from the storage unit 111 and executes the loaded software, and thereby performs the processing of the evacuation route generation unit 2 described above with reference to FIG. 3 in the second example embodiment. The arithmetic unit 112 may be, for example, an MPU (Micro Processing Unit) or a CPU (Central Processing Unit). Further, the arithmetic unit 112 may include a plurality of processors.

In the storage unit 111, one or a plurality of programs including a set of instructions for causing the arithmetic unit 112 to perform the processing of the evacuation route generation unit 2 are recorded.

Further, in the storage unit 111, various items of information necessary for the arithmetic unit 112 to determine an evacuation route, such as position information of an evacuation destination candidate, position information of an evacuee's original place, and map data in which passageways that may become evacuation route candidates is recorded, may be stored. Then, the storage unit 111 may output these items of information to the arithmetic unit 112 as required.

Note that the program includes a set of instructions (or software codes) that, when loaded onto a computer, causes the computer to perform one or a plurality of functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disc (DVD), a Blu-ray (Registered Trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

By the above-described configuration, the evacuation support system according to the present disclosure can also determine an evacuation destination based on crowdedness information of an evacuation destination, generate an evacuation route, and guide evacuees.

### Fourth Example Embodiment

### <Configuration of Evacuation Support System>

An evacuation support system 1004 according to a fourth example embodiment is a second specific example of the evacuation support system 1002 according to the second example embodiment. A configuration of the evacuation support system according to the fourth example embodiment will be described hereinafter in detail with reference to the drawings.

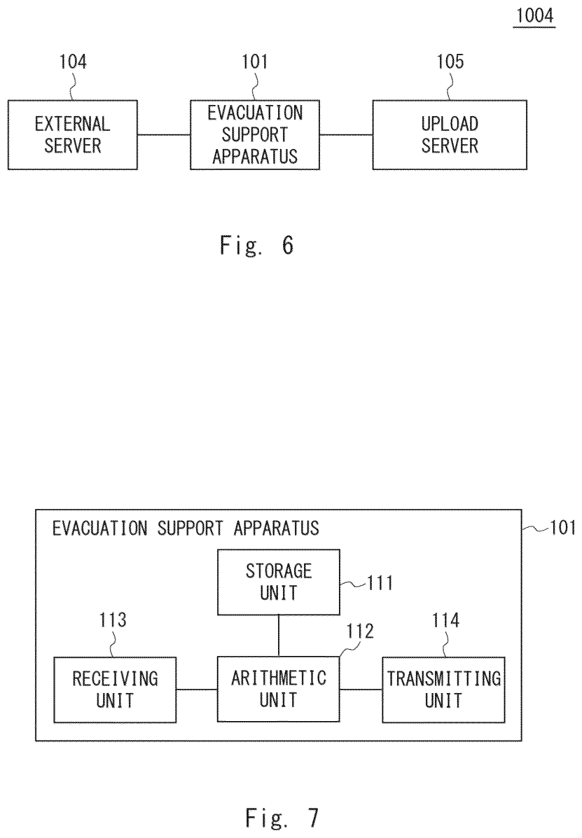

FIG. 6 is a block diagram showing a configuration of an evacuation support system according to the fourth example embodiment. The evacuation support system 1003 according to the fourth example embodiment includes an evacuation support apparatus 101, an external server 104, and an upload server 105.

Note that although only one external server 104 and one upload server 105 are shown in the drawing for the sake of simplicity, a plurality of external servers 104 and a plurality of upload servers 105 may be provided.

The external server 104 is a server apparatus that acquires information about an evacuation destination candidate, an evacuee's original place, or passageways that may become evacuation route candidates from an apparatus located outside the evacuation support system, and transmits the acquired information as crowdedness information to the evacuation support apparatus 101.

Note that examples of apparatus located outside the evacuation support system include an on-board camera mounted on a vehicle running in a nearby area or a monitoring camera installed in a nearby area. Further, examples also include a terminal apparatus or the like possessed by an evacuee or an evacuation guide.

The upload server 105 is a server apparatus that acquires information about an evacuation route from the evacuation support apparatus 101, and makes the acquired information about the evacuation route available to a terminal apparatus or the like possessed by an evacuee or an evacuation guide.

Note that the information about the evacuation route may be directly transmitted to a terminal apparatus or the like possessed by an evacuee or an evacuation guide without using the upload server interposed therebetween.

The evacuation support apparatus 101 according to the fourth example embodiment acquires information about an evacuation destination candidate, an evacuee's original place, or passageways that may become evacuation route candidates from the external server 104, and determines an evacuation route based on the acquired information. Then, the evacuation support apparatus 101 transmits information about the determined evacuation route to the upload server 105.

That is, the evacuation support apparatus 101 according to the fourth example embodiment corresponds to the acquisition unit 1, the evacuation route generation unit 2, and the notification unit 3 in the first and second example embodiments. That is, the evacuation support apparatus 101 according to the fourth example embodiment can be regarded as an evacuation support system according to the first or second example embodiment, implemented as a single apparatus.

FIG. 7 is a block diagram showing a configuration of an evacuation support apparatus according to the fourth example embodiment. The evacuation support apparatus 101 according to the fourth example embodiment includes a storage unit 111, an arithmetic unit 112, a receiving unit 113, and a transmitting unit 114.

It should be noted that preferred embodiments of the storage unit 111 and the arithmetic unit 112 are similar to those of the third example embodiment, and therefore detailed descriptions thereof will be omitted.

The receiving unit 113 receives information about an evacuation destination candidate, an evacuee's original place, or passageways that may become evacuation route candidates from the external server 104, and outputs the received information to the arithmetic unit 112. That is, the receiving unit 113 corresponds to the acquisition unit 1 according to the first or second example embodiments.

Note that the information about an evacuation destination candidate, an evacuee's original place, or passageways that may become evacuation route candidates includes at least crowdedness information of an evacuation destination candidate.

The transmitting unit 114 acquires information about the determined evacuation route from the arithmetic unit 112, and transmits the acquired information to the upload server 105. That is, the transmitting unit 114 corresponds to the notification unit 3 according to the first or second example embodiments.

By the above-described configuration, the evacuation support system according to the present disclosure can also determine an evacuation destination based on crowdedness information of an evacuation destination, generate an evacuation route, and guide evacuees.

Although the present disclosure has been described above with reference to the above-described example embodiments, the present disclosure is not limited to the configurations of the above-described example embodiments. Needless to say, the present disclosure includes various modifications, corrections, and combinations that can be made by a person skilled in the art within the scope of the claims.

The whole or part of the example embodiments disclosed above can be described as, but not limited to, the following supplementary notes.

### (Supplementary Note 1)

An evacuation support system comprising:
an acquisition unit configured to acquire position information of an evacuee's original place and crowdedness information of an evacuation destination candidate;
an evacuation route generation unit configured to determine an evacuation destination based on the crowdedness information, and generate an evacuation route from the evacuee's original place to the determined evacuation destination; and
a notification unit configured to notify an evacuee of the generated evacuation route.

### (Supplementary Note 2)

The evacuation support system described in Supplementary note 1, wherein
the evacuation route generation unit generates the evacuation route candidate,
the acquisition unit acquires crowdedness information of the evacuation route candidate, and
the evacuation route generation unit determines an evacuation route based on the crowdedness information of the evacuation route candidate.

### (Supplementary Note 3)

The evacuation support system described in Supplementary note 2, wherein the evacuation route generation unit changes the evacuation destination based on the crowdedness information of the evacuation route candidate.

### (Supplementary Note 4)

The evacuation support system described in Supplementary note 2 or 3, wherein
the acquisition unit further acquires movement information of a person present in the evacuation route, and
the evacuation route generation unit predicts a change in the crowdedness information of the evacuation destination candidate based on the movement information, and determines an evacuation destination based on the predicted change in the crowdedness information of the evacuation destination candidate.

### (Supplementary Note 5)

The evacuation support system described in any one of Supplementary notes 1 to 4, wherein the evacuation route generation unit preferentially determines an evacuation destination candidate that is less crowded among evacuation destination candidates as the evacuation destination.

### (Supplementary Note 6)

The evacuation support system described in any one of Supplementary notes 1 to 5, wherein the evacuation route generation unit preferentially determines an evacuation destination candidate in which there is no emergency vehicle as the evacuation destination.

### (Supplementary Note 7)

The evacuation support system described in any one of Supplementary notes 1 to 6, wherein
the evacuee's original place is a place where there is a person moving in a facility or a predetermined area, and
the evacuation destination candidates are a plurality of entrances or exits of the facility.

### (Supplementary Note 8)

The evacuation support system described in Supplementary note 7, wherein the crowdedness information of the evacuation destination candidate includes a crowdedness state of a road accessible from an entrance or exit of the facility.

### (Supplementary Note 9)

The evacuation support system described in Supplementary note 7 or 8, wherein
the facility includes a plurality of levels, and
when a level of the evacuee's original place differs from a level of the determined evacuation destination, the evacuation route generation unit generates an evacuation route that extends over a plurality of levels.

### (Supplementary Note 10)

An evacuation support apparatus comprising:
a storage unit in which position information of an evacuation destination candidate is stored; and
an arithmetic unit configured to acquire crowdedness information of the evacuation destination candidate, determine an evacuation destination based on the crowdedness information, and generate an evacuation route from an evacuee's original place to the determined evacuation destination.

### (Supplementary Note 11)

The evacuation support apparatus described in Supplementary note 10, wherein the arithmetic unit acquires image data obtained by photographing the evacuation destination candidate as the crowdedness information, image-processes the image data, and evaluates a crowdedness level of the evacuation destination candidate.

### (Supplementary Note 12)

The evacuation support apparatus described in Supplementary note 10 or 11, further comprising:
a receiving unit configured to receive the crowdedness information; and
a transmitting unit configured to transmit the generated evacuation route.

### (Supplementary Note 13)

An evacuation support method comprising:
acquiring crowdedness information of an evacuation destination candidate;
determining an evacuation destination based on the crowdedness information;
generating an evacuation route from an evacuee's original place to the determined evacuation destination; and
notifying an evacuee of the generated evacuation route.

### (Supplementary Note 14)

A non-transitory computer readable medium storing a program for causing a computer to perform:
acquiring crowdedness information of an evacuation destination candidate;
determining an evacuation destination based on the crowdedness information;
generating an evacuation route from an evacuee's original place to the determined evacuation destination; and
notifying an evacuee of the generated evacuation route.

### REFERENCE SIGNS LIST

1 ACQUISITION UNIT
2 EVACUATION ROUTE GENERATION UNIT
3 NOTIFICATION UNIT
11 EVACUATION DESTINATION INFORMATION ACQUISITION UNIT
12 EVACUEE ORIGINAL PLACE INFORMATION ACQUISITION UNIT
13 ROUTE INFORMATION ACQUISITION UNIT
21 EVACUATION DESTINATION DETERMINATION UNIT
22 ROUTE GENERATION UNIT
23 ROUTE DETERMINATION UNIT
101 EVACUATION SUPPORT APPARATUS
102 MONITORING CAMERA
103 DISPLAY DEVICE
104 EXTERNAL SERVER
105 UPLOAD SERVER
111 STORAGE UNIT
112 ARITHMETIC UNIT
113 RECEIVING UNIT
114 TRANSMITTING UNIT
1001, 1002, 1003, 1004 EVACUATION SUPPORT SYSTEM

What is claimed is:

1. An evacuation support system comprising:
at least one memory storing instructions, and
at least one processor configured to execute the instructions to;
acquire position information of an evacuee's original place and crowdedness information of an evacuation destination candidate;
determine an evacuation destination based on the crowdedness information, and generate an evacuation route from the evacuee's original place to the determined evacuation destination; and
notify an evacuee of the generated evacuation route.

2. The evacuation support system according to claim 1, wherein the at least one processor is further configured to execute the instructions to generate the evacuation route candidate, and acquire crowdedness information of the evacuation route candidate, and determine an evacuation route based on the crowdedness information of the evacuation route candidate.

3. The evacuation support system according to claim 2, wherein the at least one processor is further configured to execute the instructions to change the evacuation destination based on the crowdedness information of the evacuation route candidate.

4. The evacuation support system according to claim 2, wherein the at least one processor is further configured to execute the instructions to acquire movement information of a person present in the evacuation route, and predict a change in the crowdedness information of the evacuation destination candidate based on the movement information, and determine an evacuation destination based on the predicted change in the crowdedness information of the evacuation destination candidate.

5. The evacuation support system according to claim 1, wherein the at least one processor is further configured to execute the instructions to preferentially determine an evacuation destination candidate that is less crowded among evacuation destination candidates as the evacuation destination.

6. The evacuation support system according to claim 1, wherein the at least one processor is further configured to execute the instructions to preferentially determine an evacuation destination candidate in which there is no emergency vehicle as the evacuation destination.

7. The evacuation support system according to claim 1, wherein
the evacuee's original place is a place where there is a person moving in a facility or a predetermined area, and
the evacuation destination candidates are a plurality of entrances or exits of the facility.

8. The evacuation support system according to claim 7, wherein the crowdedness information of the evacuation destination candidate includes a crowdedness state of a road accessible from an entrance or exit of the facility.

9. The evacuation support system according to claim 7, wherein
the facility includes a plurality of levels, and
when a level of the evacuee's original place differs from a level of the determined evacuation destination, the at least one processor is further configured to execute the instructions to generate an evacuation route that extends over a plurality of levels.

10.-12. (canceled)

13. An evacuation support method comprising:
acquiring crowdedness information of an evacuation destination candidate;
determining an evacuation destination based on the crowdedness information;
generating an evacuation route from an evacuee's original place to the determined evacuation destination; and
notifying an evacuee of the generated evacuation route.

14. A non-transitory computer readable medium storing a program for causing a computer to perform:
acquiring crowdedness information of an evacuation destination candidate;
determining an evacuation destination based on the crowdedness information;
generating an evacuation route from an evacuee's original place to the determined evacuation destination; and
notifying an evacuee of the generated evacuation route.
